(19) United States
(12) Patent Application Publication
(10) Pub. No.: US 2015/0043414 A1
(43) Pub. Date: Feb. 12, 2015

(54) COMMUNICATION METHOD OF ACCESS POINT (AP) AND TERMINAL TO RETRANSMIT MULTICAST PACKET BASED ON FEEDBACK IN NETWORK

(71) Applicant: Samsung Electronics Co., Ltd., Suwon-si (KR)

(72) Inventors: Kwang Hoon HAN, Suwon-si (KR); Kyung Hun JANG, Suwon-si (KR)

(73) Assignee: Samsung Electronics Co., Ltd., Suwon-si (KR)

(21) Appl. No.: 14/224,515

(22) Filed: Mar. 25, 2014

(30) Foreign Application Priority Data
Aug. 8, 2013 (KR) 10-2013-0094121

(51) Int. Cl. H04W 72/00

(52) U.S. Cl. CPC H04W 72/005
USPC 370/312

(57) ABSTRACT

An access point (AP) and a terminal and corresponding methods are provided configured to retransmit a multicast packet based on feedback in a network. The network includes the AP and terminals. The communication method of the AP includes transmitting coded packet based multicast packets to the terminals, receiving, from a terminal, a feedback message indicating whether the multicast packets are received in response to the transmission, and retransmitting at least one multicast packet to the terminal in response to the feedback message.

### CROSS-REFERENCE TO RELATED APPLICATION(S)

This application claims the benefit under 35 USC §119(a) of Korean Patent Application No. 10-2013-0094121, filed on Aug. 8, 2013, in the Korean Intellectual Property Office, the entire disclosure of which is incorporated herein by reference for all purposes.

### BACKGROUND

1. Field

The following description relates to a communication method in a network between an access point (AP) and a terminal to retransmit a multicast packet based on feedback.

2. Description of Related Art

Multicast differs from unicast in several aspects. For example, because a multicast provides a service to multiple users, a determination on whether the service is transferred properly may be difficult. When such a determination is performed, a consequent overhead may rapidly increase as a number of users increases. In addition, a number of multicast/broadcast services may need to be transferred in real time, and due to characteristics of a wireless channel, the multicast/broadcast services may be variable in terms of time, a location, and numerous other factors.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In accordance with an illustrative example, there is provided a communication method of an access point (AP), the communication method includes transmitting a plurality of coded packet based multicast packets to terminals; receiving, from a terminal, a feedback message indicating whether the multicast packets are received at the terminals; and retransmitting a multicast packet to the terminal in response to the feedback message.

The retransmitting may include calculating a number of multicast packets to be retransmitted based on a length of the feedback message and outputting a result indicative thereof; and retransmitting the multicast packet based on the result.

The retransmitting may include measuring an accumulation level of the feedback message and a length of the feedback message and outputting a result indicative thereof; and determining a transmission scheme to retransmit the multicast packet based on the result.

The transmitting may include adding to a header of one of the multicast packets information indicating that the one multicast packet is a last multicast packet; and transmitting to the terminals the multicast packet to which the information is added.

The transmitting may include transmitting a request message requesting the terminals to provide a feedback message when one of the multicast packets is a last multicast packet.

The communication method may also include determining an error rate of a terminal based on an accumulation level of the feedback message.

The communication method may further include terminating retransmission of the multicast packet in response to the feedback message being provided.

The feedback message may be provided using one of an unsolicited scheme from the terminal and a solicited scheme by the AP.

The feedback message may include one of a negative acknowledgement (NACK) message indicating a failed reception of one of the multicast packets and an acknowledgement (ACK) message indicating a successful reception of one of the multicast packets.

In accordance with an illustrative example, there is provided a communication method of a terminal, the communication method including receiving a plurality of coded packet based multicast packets from an access point (AP); determining one of the multicast packets as a last multicast packet and outputting a result indicative thereof; and providing, to the AP, a feedback message indicating whether the multicast packets are received based on the result.

The determining of the last multicast packet may be based on reading information from a header of the one multicast packet.

The providing may include generating the feedback message when one of the multicast packets is determined to be the last multicast packet.

The generating may include generating the feedback message to be retransmitted at the terminal based on a number of multicast packets or a set of multicast packets desired.

A length of the feedback message to be retransmitted may vary based on a number of multicast packets or a set of multicast packets desired, by the at least one terminal.

The providing may include providing the feedback message at a predetermined time to the AP.

In accordance with an illustrative example, there is provided communication method of a terminal, the communication method including receiving a plurality of coded packet based multicast packets from an access point (AP); determining whether one of the multicast packets is a request packet requesting transmission of a feedback message and outputting a result indicative thereof, wherein the feedback message indicates whether the multicast packets are received; generating the feedback message based on the result; and transmitting the feedback message to the AP.

The generating may include generating the feedback message to be retransmitted from a terminal based on a number of multicast packets or a set of multicast packets desired.

In accordance with an illustrative example, there is provided a non-transitory computer-readable medium configured to control a processor to perform the method described above.

In accordance with an illustrative example, there is also provided an access point (AP), including a transmitter configured to transmit a plurality of coded packet based multicast packets to terminals; a receiver configured to receive, from one of the terminals, a feedback message indicating whether the multicast packets are received at the terminals; a calculator configured to calculate a number of multicast packets to be retransmitted based on a length of the feedback message and to output a result indicative thereof; and a retransmitter configured to retransmit a multicast packet to the terminal based on the result.

The calculator may be further configured to determine an error rate of a terminal based on an accumulation level of the feedback message.

The calculator may be further configured to perform an open-loop rate control using the result.

In accordance with an illustrative example, there is further provided a terminal, including a receiver configured to receive a plurality of coded packet based multicast packets from an access point (AP); a determiner configured to determine one of the multicast packets as a last multicast packet and to output a result indicative thereof; and a feedback unit configured to provide, to the AP, a feedback message indicating whether the multicast packets are received based on the result.

The determiner may be configured to determine the last multicast packet by reading information in a header of the one multicast packet.

In accordance with another illustrative example, there is provided a terminal, including a receiver configured to receive a plurality of coded packet based multicast packets from an access point (AP); a determiner configured to determine whether one of the multicast packets is a request packet requesting transmission of a feedback message and to output a result indicative thereof, wherein the feedback message indicates whether the multicast packets are received; a generator configured to generate the feedback message based on the result; and a feedback unit configured to transmit the feedback message to the AP.

Other features and aspects will be apparent from the following detailed description, the drawings, and the claims.

### BRIEF DESCRIPTION OF THE DRAWINGS

These and/or other aspects will become apparent and more readily appreciated from the following description of the embodiments, taken in conjunction with the accompanying drawings in which:

FIG. 1 is a diagram illustrating an example of a network environment in which a communication method to retransmit multicast packets based on feedback is performed, in accord with an embodiment.

FIG. 2 is a diagram illustrating an example of coded packet based multicast used in a communication method to retransmit a multicast packet based on feedback, in accord with an embodiment.

FIG. 3 is a flowchart illustrating an example of a communication method of an access point (AP) to retransmit a multicast packet based on feedback, in accord with an embodiment.

FIG. 4 is a flowchart illustrating another example of a communication method of an AP to retransmit a multicast packet based on feedback, in accord with another embodiment.

FIG. 5 is a diagram illustrating an example of an AP receiving a negative acknowledgement (NACK) message, in accord with an embodiment.

FIG. 6 is a diagram illustrating an example of an unsolicited scheme to transmit a feedback message indicating whether a multicast packet is received, in accord with an embodiment.

FIG. 7 is a flowchart illustrating an example of a method to provide a feedback message indicating whether multicast packets are received, using an unsolicited scheme from a terminal, in accord with an embodiment.

FIG. 8 is a diagram illustrating an example of a solicited scheme to transmit a feedback message indicating whether a multicast packet is received, in accord with an embodiment.

FIG. 9 is a flowchart illustrating an example of a method to provide a feedback message indicating whether multicast packets are received, using a solicited scheme from a terminal, in accord with an embodiment.

FIG. 10 is a diagram illustrating an example of an AP receiving an acknowledgement (ACK) message, in accord with an embodiment.

FIG. 11 is a diagram illustrating an example of a method of feeding back an ACK message from a terminal, in accord with an embodiment.

FIG. 12 is a diagram illustrating an example of transferring a multicast packet via a wireless local area network (WLAN) using coded packet based multicast packets, in accord with an embodiment.

FIG. 13 is a block diagram illustrating an example of an AP to retransmit a multicast packet based on feedback, in accord with an embodiment.

FIG. 14 is a block diagram illustrating an example of a terminal to retransmit a multicast packet based on feedback, in accord with an embodiment.

FIG. 15 is a block diagram illustrating another example of a terminal to retransmit a multicast packet based on feedback, in accord with another embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, description of well-known functions and constructions may be omitted for increased clarity and conciseness.

The terminology used herein is for the purpose of describing particular embodiments only and is not intended to be limiting of the present invention. As used herein, the singular forms “a,” “an” and “the” are intended to include the plural forms as well, unless the context clearly indicates otherwise.

Hereinafter, the term “terminal” may include various customer devices having a communication function. For example, the various customer devices may include, but are not limited to, a user terminal such as a smart phone, a smart television (TV), a personal computer (PC), a laptop computer, a robotic vacuum cleaner, and a processor, or a controller. The term “access point (AP)” refers to a transmission subject configured to transmit a multicast packet through wired and wireless communication, and may include various network entities or devices configured to perform the same or a similar function.

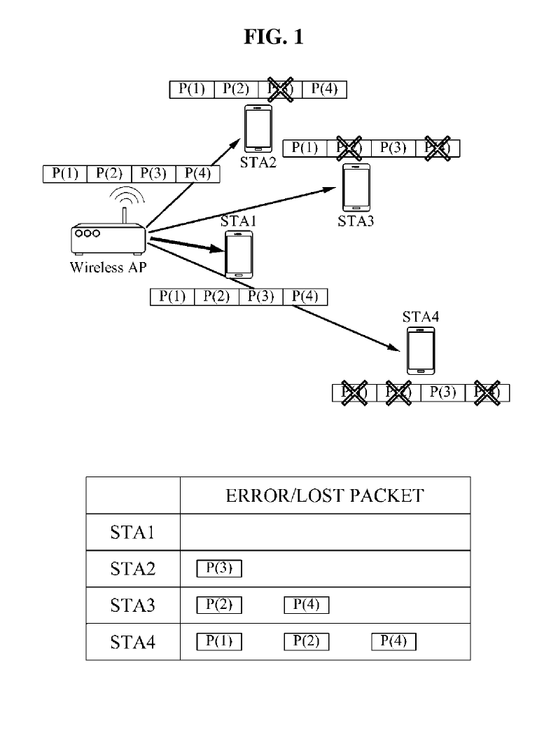

FIG. 1 illustrates an example of a network environment in which a communication method to retransmit multicast packets based on feedback is performed, in accord with an embodiment.

FIG. 1 illustrates the network environment in which multicast packets are wirelessly transferred.

A wireless AP transmits four packets P(1), P(2), P(3), and P(4) to four terminals STA1, STA2, STA3, and STA4. A number of packets may be lost at each terminal depending on a channel situation, for example, a channel state. In one configuration, the four packets P(1), P(2), P(3), and P(4) may be transmitted simultaneously to the four terminals STA1, STA2, STA3, and STA4. In another configuration, the four packets P(1), P(2), P(3), and P(4) may be transmitted in a predetermined order to the four terminals STA1, STA2, STA3, and STA4.

In contrast to a wired system, a packet error may be determined based on a channel state of at least one of the four terminals STA1, STA2, STA3, and STA4 in the wireless system. Accordingly, the packet error and packet loss may occur in different patterns, as shown in a lower part of FIG. 1. In addition, in the wireless system, a complexity of a feedback scheme may increase due to the packet error and packet loss with different patterns.

When a packet error occurs, the wireless system may not provide any feedback, or provide feedback using a scheme used for unicast. When feedback is not provided, a reliability of a multicast service may decrease. When unicast-based feedback is provided, feedback efficiency may decrease. For example, the wireless system, such as a wireless local area network (WLAN), may not have an efficient feedback scheme to multicast and; thus, provision of a stable wireless service may be difficult.

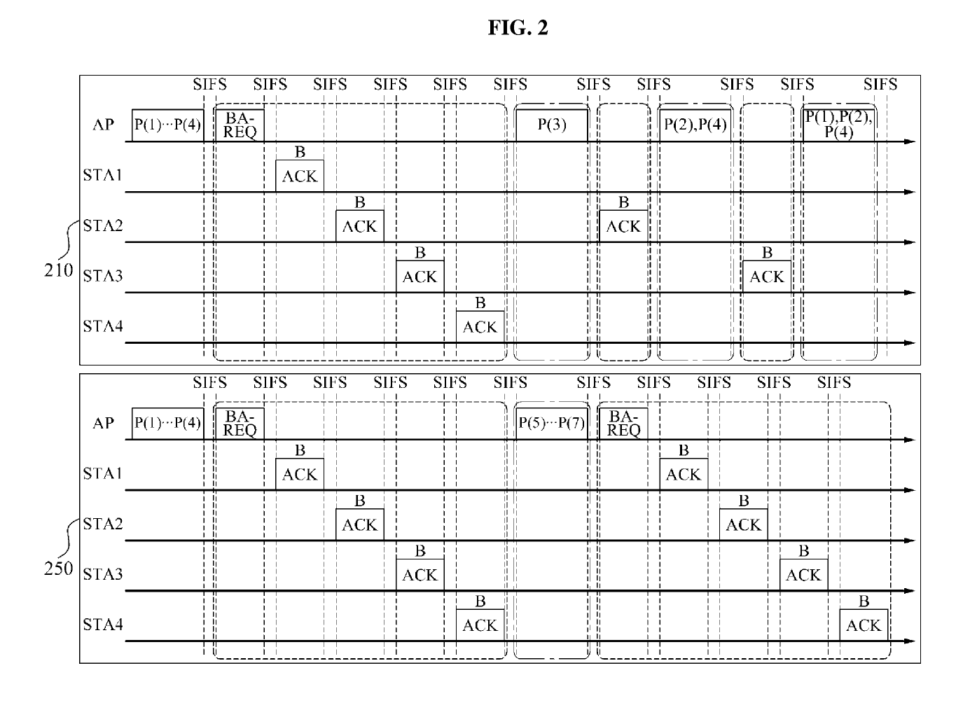

FIG. 2 illustrates an example of coded packet based multicast used in a communication method to retransmit a multicast packet based on feedback, in accord with an embodiment.

Referring to FIG. 2, feedback with respect to an uncoded packet based multicast 210 and feedback with respect to a coded packet based multicast 250 may be performed.

In the uncoded packet based multicast 210, an AP requests all terminals STA1, STA2, STA3, and STA4 in the communications network to provide feedback with respect to all packets received at each terminal in a form of a block acknowledgement (block ACK).

For example, in the uncoded packet based multicast 210, the AP transmits a block ACK request (BA-REQ) as feedback to all of the terminals STA1, STA2, STA3, and STA4. In the uncoded packet based multicast 210, an amount of the feedback may increase in proportion to a number of the terminals. Also, in the uncoded packet based multicast 210, the AP restores lost packets separately for each terminal. As a result, the AP may have an additional feedback burden of the same level as unicast.

In the coded packet based multicast 250, the AP is fed back with a number of packets requested for each terminal, rather than packets lost for each terminal.

For example, a coded packet refers to a packet coded in a form of, for example, aP₁+bP₂+cP₃=Y₁, and dP₁+aP₂+bP₃=Y₂. Thus, the AP may retransmit packets corresponding to the number of the requested packets, rather than individual packets requested for each terminal.

Accordingly, in the coded packet based multicast 250, an amount of feedback may be relatively lower. Nevertheless, a feedback overhead may increase as the number of the terminals increases.

The coded packet may be generated using, for example, network coding or rateless coding.

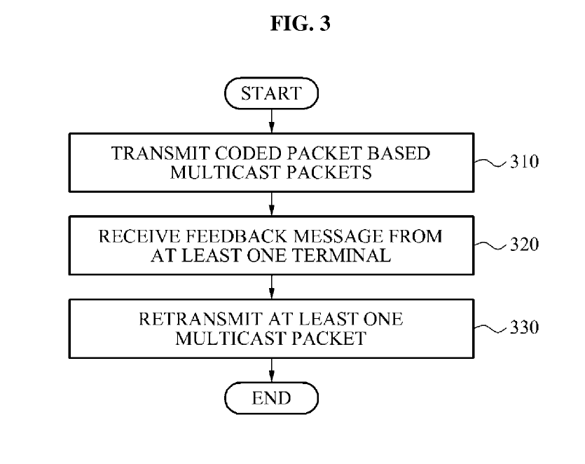

FIG. 3 illustrates an example of a communication method of an AP to retransmit a multicast packet based on feedback, in accord with an embodiment.

Referring to FIG. 3, at operation 310, the method transmits from the AP to terminals coded packet based multicast packets.

At operation 320, in response to the transmission performed at operation 310, the method at the AP receives from at least one of the terminals a feedback message indicating whether the multicast packets are received.

The feedback message may include one of a negative acknowledgement (NACK) message indicating a failed reception of at least one of the multicast packets and an acknowledgement (ACK) message indicating a successful reception of at least one of the multicast packets.

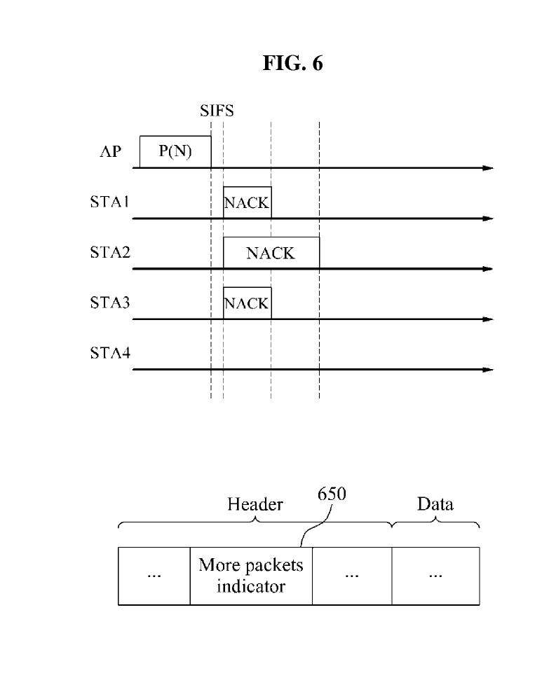

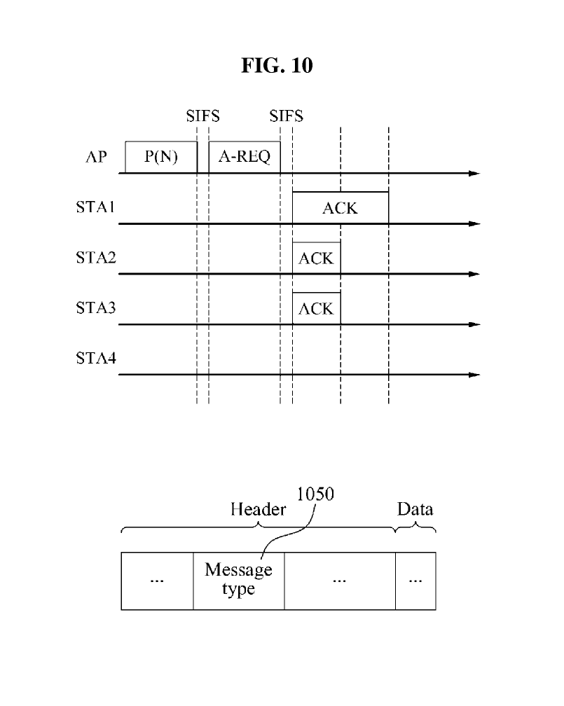

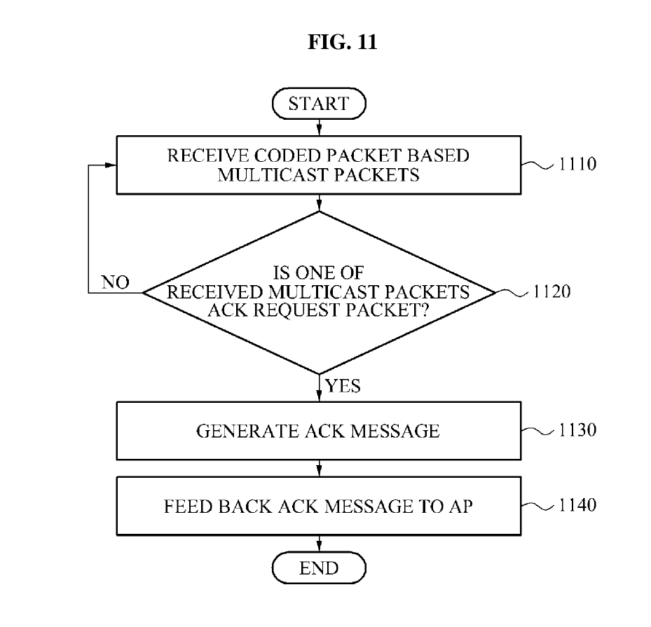

A case in which the feedback message corresponds to the NACK message will be described with reference to FIGS. 6 through 9, and a case in which the feedback message corresponds to the ACK message will be described with reference to FIGS. 10 and 11.

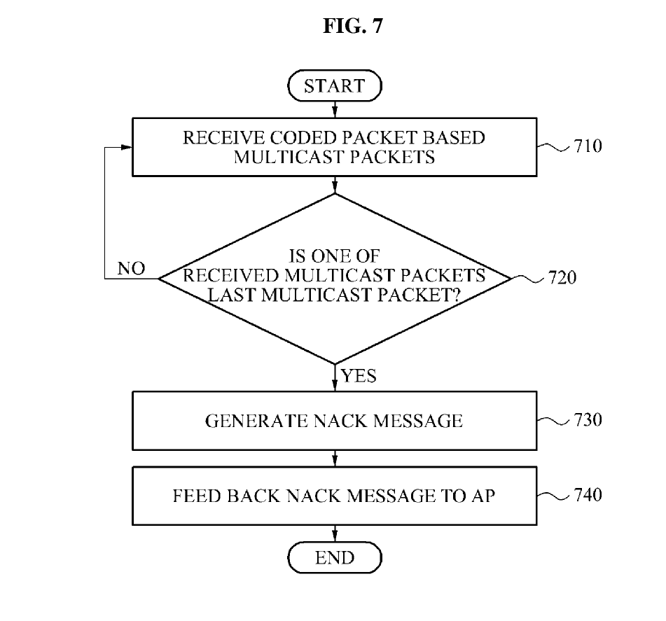

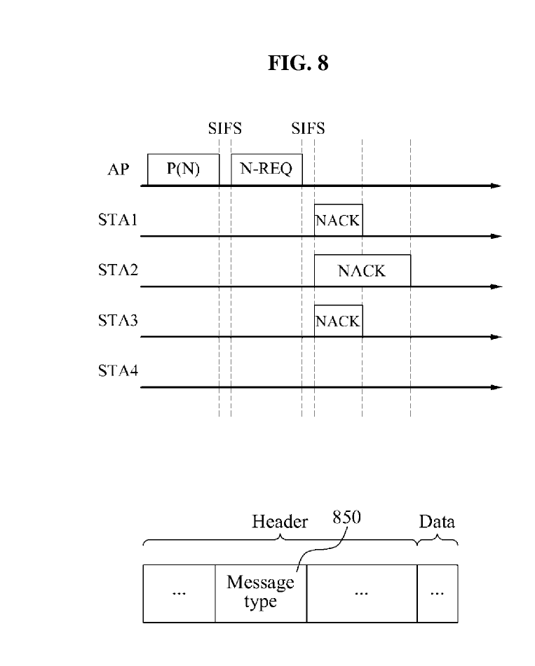

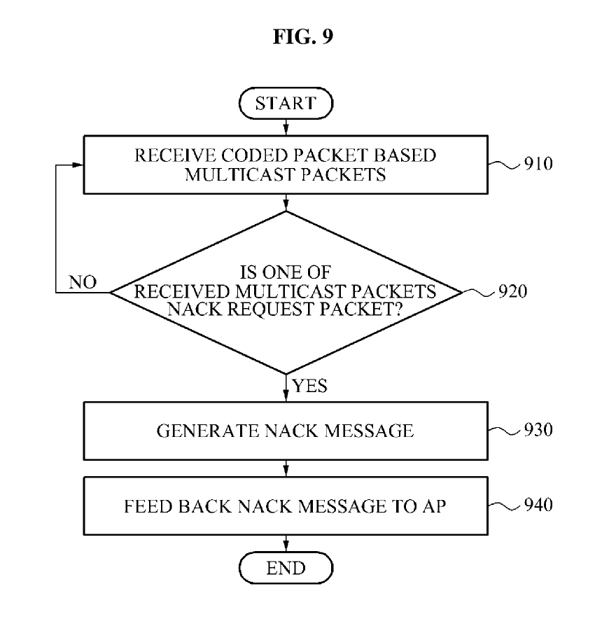

The feedback message may be provided using one of an unsolicited scheme from the at least one terminal and a solicited scheme from the AP. The unsolicited scheme will be described with reference to FIGS. 6 and 7, and the solicited scheme will be described with reference to FIGS. 8 and 9.

At operation 330, the method at the AP retransmits at least one multicast packet to the at least one terminal based on the feedback message received in operation 320.

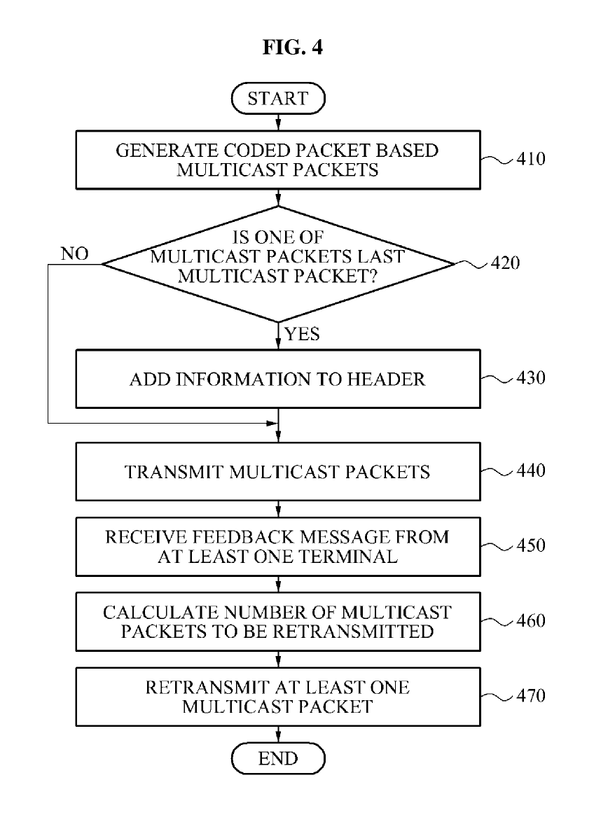

FIG. 4 illustrates another example of a communication method of an AP to retransmit a multicast packet based on feedback, in accord with an embodiment.

Referring to FIG. 4, at operation 410, the method at the AP generates coded packet based multicast packets.

At operation 420, the AP determines whether one of the multicast packets is a last multicast packet. In response to determining at operation 420 that one of the multicast packets is not the last multicast packet, at operation 440, the AP transmits the generated multicast packets. In contrast, in response to determining at operation 420 that one of the multicast packets is the last multicast packet, at operation 430, the AP adds information to a header of the one multicast packet. The information indicates that the one multicast packet is the last multicast packet. The information indicating that the one multicast packet is the last multicast packet may include, for example, a more packets indicator. The more packets indicator may be set to “0” when the one multicast packet is the last multicast packet.

Depending on an embodiment, when the one multicast packet is the last multicast packet, the AP may transmit a request message requesting terminals to provide a feedback message indicating whether the multicast packets are received.

At operation 440, the AP transmits the multicast packets to the terminals. In this example, the multicast packet transmitted by the AP may include a multicast packet to which information is added. The information may indicate that the one multicast packet is a last packet.

At operation 450, in response to the transmission performed in 440, the AP receives the feedback message from at least one terminal. The feedback message may include one of a NACK message indicating a failed reception of at least one of the multicast packets and an ACK message indicating a successful reception of at least one of the multicast packets. In accordance with an illustrative example, various types of messages or packets, for example, a dummy packet, or an orthogonal code may be used as the feedback message or a feedback packet provided from a terminal.

At operation 460, based on a length of the feedback message, the method at the AP calculates a number of multicast packets to be retransmitted.

At operation 470, as a result of the calculation performed at operation 460, the AP retransmits at least one multicast packet to the at least one terminal. The AP may determine whether at least one multicast packet is to be retransmitted based on the feedback message. For example, when the AP is not fed back with the NACK message from any terminal, the method at the AP may terminate the retransmission of the at least one multicast packet.

In accord with an embodiment, the AP measures an accumulation level of the feedback messages and a length of the feedback messages.

The AP may retransmit at least one multicast packet, based on a result of the measuring. The AP may construe the accumulation level of the feedback messages as a final length or a longest length of accumulated feedback messages or accumulated feedback packets received from the terminals. The AP verifies a maximum number of packets requested by the terminals based on the final length of the accumulated feedback messages.

The AP measures power of the accumulated feedback messages or the accumulated feedback packets, and predicts an accumulation level of each packet section. When the feedback messages or the feedback packets include orthogonal codes, the method at the AP resolves the orthogonal codes to identify the terminals, for example, respective users transmitting the accumulated feedback messages.

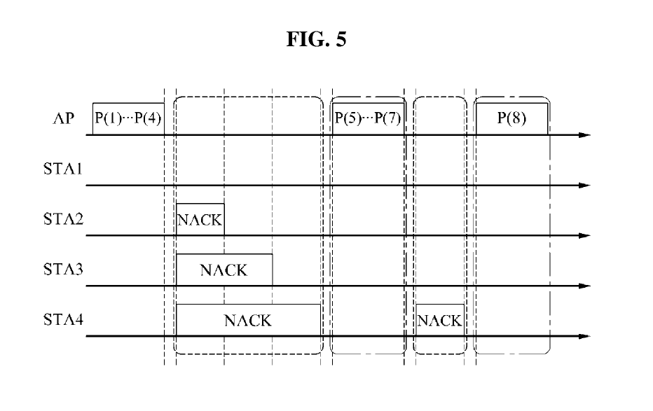

FIG. 5 illustrates an example of an AP receiving a NACK message, as an example of a feedback message indicating whether a plurality of multicast packets is received, in accord with an embodiment.

Referring to FIG. 5, feedback may be performed between the AP and terminals based on NACK messages.

In order for a terminal to be provided with a multicast service, the terminal receives a sufficient number of packets or a set of all required packets. When the aforementioned condition is not satisfied, the terminal may feed back a NACK message or a NACK packet to the AP to notify a state of the terminal.

A length of the NACK message to vary based on a number of packets or a set of packets the terminal desires to additionally receive or to be retransmitted.

A method to determine the length of the NACK message may be agreed to in advance between the AP and the terminal. For example, a protocol that “the terminal generates a NACK message having a length corresponding to n times a unit time when the terminal wants n packets to be retransmitted” may be agreed to in advance between the terminal and the AP.

When the AP transmits multicast packets P(1) through P(4), terminals having prepared for feedback, for example, STA2, STA3, and STA4, may feed back NAC messages to the AP. The NACK messages may have variable lengths generated by the terminals.

Each of the terminals may determine the length of the NACK message based on a number of required packets to be retransmitted. For example, as shown in FIG. 5, the terminal STA2 may require a single packet to be retransmitted, the terminal STA3 may require two packets to be retransmitted, and the terminal STA4 may require three packets to be retransmitted. The terminal STA2 may generate a NACK message having a length corresponding to a unit time. The terminal STA3 may generate a NACK message having a length corresponding to two times a unit time. The terminal STA4 may generate a NACK message having a length corresponding three times a unit time.

In one configuration, the terminals STA2, STA3, and STA4 providing feedback transmit NACK messages to the AP simultaneously at a point in time at which a short interframe space (SIFS) elapses after the multicast packets are transmitted from the AP. In an alternative configuration, the terminals STA2, STA3, and STA4 providing feedback transmit NACK messages to the AP at a predetermined sequence, such as a sequential sequence, from a point in time at which a short interframe space (SIFS) elapses after the multicast packets are transmitted from the AP. The foregoing process may be performed continuously for every retransmission.

Since the lengths of the NACK messages fed from the terminals back to the AP may differ from each other, the AP may be fed back with accumulated NACK messages in a form in which an amount of power received per unit time decreases.

The AP may determine a number of packets requested in a network based on the length of the NACK message. For example, as shown in FIG. 5, the AP may generate and transmit three new multicast packets P(5) through P(7), based on the NACK messages fed to the AP back from the terminals STA2, STA3, and STA4, respectively.

In the case of the packets P(5) through P(7), the terminals STA2 and STA3 may successfully receive required numbers of packets, and the terminal STA4 may receive packets including a single error packet. In this example, the AP may retransmit a single packet P(8) required by the terminal STA4 so that all terminals may successfully receive the multicast packets.

When NACK messages are not fed to the AP back from all of the terminals STA1, STA2, STA3, and STA4, the AP determines that all of the multicast packets are successfully transferred, and terminates packet retransmission.

The AP determines a number of packets to be retransmitted and a transmission scheme, based on received power of the NACK messages.

FIG. 6 illustrates an example of an unsolicited scheme to transmit a feedback message indicating whether a multicast packet is received, in accord with an embodiment.

The unsolicited scheme refers to a method in which, without a trigger, an AP informs each terminal that transmission of multicast packets is terminated. In particular, the unsolicited scheme refers to a scheme or a method to enable a terminal to feed back a NACK message, without transmitting to the terminal a special packet informing that transmission of multicast packets is terminated.

Referring to FIG. 6, in the unsolicited scheme, the AP adds to a header of a multicast packet P(N), information indicating that the one multicast packet is a last multicast packet, and transmits the multicast packet P(N) to a terminal. The information indicating that the one multicast packet is the last multicast packet may include, for example, a more packets indicator 650.

The terminals STA1, STA2, and STA3 that fail to receive the multicast packet, transmit NACK messages based on a predetermined condition and without a request from the AP, for example, a reception of the more packets indicator 650. Each of the terminals STA1, STA2, and STA3 may transmit a NACK message at a point in time at which an SIFS elapses, after the AP terminates transmission of the multicast packet.

FIG. 7 illustrates an example of a method to provide a feedback message indicating whether multicast packets are received, using an unsolicited scheme from a terminal, in accord with an embodiment.

Referring to FIG. 7, at operation 710, the method at the terminal receives coded packet based multicast packets from an AP.

At operation 720, the terminal determines whether one of the multicast packets received is a last multicast packet, based on information included in a header of the one multicast packet. When a more packets indicator is included in the header of the one multicast packet, the terminal determines the one multicast packet to be the last multicast packet. Furthermore, the AP provides an output signal indicating whether the one multicast packet is the last multicast packet, using a reserved type of a subtype in a frame control field of a typical media access control (MAC) frame format.

When the method determines at operation 720 that one of the multicast packets is not the last multicast packet, at operation 710, the terminal receives another coded packet based on the multicast packets.

When the method determines at operation 720 that one of the multicast packets is the last multicast packet, the terminal generates a feedback message indicating whether the multicast packets are received, for example, a NACK message. In particular, at operation 730, the terminal generates a NACK message indicating whether the multicast packets are received, based on a number of multicast packets or a set of multicast packets desired to be retransmitted. A length of the feedback message generated at operation 730 may be determined to be variable based on the number of the multicast packets or the set of the multicast packets desired by the terminal to be retransmitted.

At operation 740, the terminal feeds back the NACK message to the AP. The terminal may feed back the NACK message to the AP at a predetermined time.

The AP may receive accumulated NACK messages from a plurality of terminals, through feedback performed at operation 740, and measure an accumulation level of the received packets and a length of the received packets to determine a scheme to retransmit the multicast packets. The AP retransmits at least one multicast packet based on a result of the measuring. The accumulation level of the packets may be construed as a final length or a longest length of accumulated feedback messages received at the AP from the terminals. The AP verifies a maximum number of packets requested from the terminals, based on the final length of the accumulated feedback messages.

The AP measures power of the accumulated feedback messages or the accumulated feedback packets, and predicts an accumulation level for each packet section. For example, when the feedback messages or the feedback packets include orthogonal codes, the AP resolves the orthogonal codes to identify the terminals, for example, users transmitting the accumulated feedback messages, respectively.

FIG. 8 illustrates an example of a solicited scheme to transmit a feedback message indicating whether a multicast packet is received, in accord with an embodiment.

The solicited scheme refers to a method in which an AP informs a terminal that transmission of a multicast packet is terminated. The transmission of the multicast packet is terminated by transmitting from the AP an explicit NACK request packet or a NACK request message to the terminal.

The AP generates the NACK request packet and transmits the NACK request packet at a point in time at which the transmission of the multicast packet is terminated. The NACK request packet may include in a header a message type field 850 informing that the NACK request packet is a packet requesting transmission of a NACK message.

Terminals receiving the NACK request message from the AP transmit NACK messages simultaneously at a point in time at which an SIFS elapses.

FIG. 9 illustrates an example of a method of providing a feedback message indicating whether multicast packets are received using a solicited scheme from a terminal, in accord with an embodiment.

Referring to FIG. 9, at operation 910, the terminal receives from an AP coded packet based multicast packets.

At operation 920, the terminal determines whether one of the multicast packets received is a request packet requesting transmission of a feedback message indicating whether the multicast packets are received, for example, a NACK request packet.

When the method determines at operation 920 that one of the multicast packets is not the NACK request packet, the terminal receives another coded packet based on the multicast packets at operation 910.

When the method determines at operation 920 that one of the multicast packets is the NACK request packet, at operation 930, the terminal generates a feedback message indicating whether the multicast packets is received, for example, a NACK message. The terminal generates the NACK message based on a number of multicast packets or a set of multicast packets to be retransmitted.

At operation 940, the terminal feeds back the NACK message to the AP.

The AP may receive accumulated NACK messages from a plurality of terminals, through feedback performed in 940, and measure an accumulation level of the received packets and a length of the received packet to determine a scheme to retransmit the multicast packets.

In an embodiment, a length of a feedback packet or a feedback message to be provided by the terminal may be determined based on the number of the multicast packets or the set of the multicast packets the terminal desires to be retransmitted. Accordingly, the AP determines the retransmission scheme based on the length of the feedback packet.

FIG. 10 illustrates an example of an AP receiving an ACK message as a feedback message indicating whether multicast packets are received, in accord with an embodiment.

Using a NACK message received from a terminal, the AP may have difficulty in accurately determining whether a sufficient number of packets or all required packets are received from the terminal through a multicast service. The AP accurately verifies whether the packets are successfully received using the NACK message and an ACK message.

The ACK message is optionally transmitted based on a determination of an administrator.

Referring to FIG. 10, the AP transmits an ACK request packet (A-REQ) to terminals to determine whether a multicast packet is successfully received from at least one terminal in a network. A header of the ACK request packet may include a message type field 1050 providing information that the ACK request packet is a packet requesting transmission of an ACK message.

In response to the ACK request packet, the terminals simultaneously feed back ACK messages to the AP. Each terminal adjusts a length of the ACK message to be variable based on a number of packets successfully received.

Similar to the NACK message, the length of the ACK message is determined based on a number of packets desired by the terminal to be retransmitted. In the alternative, the length of the ACK message may be determined based on a set of packets desired by the terminal to be retransmitted.

Similar to the method of determining the length of the NACK message, a method of determining the length of the ACK message is to be agreed to in advance between the AP and the terminal. For example, a protocol that “the terminal generates an ACK message having a length corresponding to n times a unit time when all packets are successfully received, and generates an ACK message having a length corresponding to n/2 times a unit time when n/2 packets are received” may be pre-agreed between the AP and the terminal.

All terminals may simultaneously feed back ACK messages when a determined time, for example, an SIFS, elapses after the AP terminates transmission of the multicast packet.

Based on a length of the ACK message, the AP determines a number of packets requested in a network, for example, a number of packets requested by the terminal to be retransmitted. When an ACK message having a length shorter than an agreed reference length is fed back, the AP verifies that the multicast packet is not successfully received by any terminal in the network.

FIG. 11 illustrates an example of a method of feeding back an ACK message from a terminal, in accord with an embodiment.

Referring to FIG. 11, at operation 1110, the terminal receives from an AP coded packet based multicast packets.

At operation 1120, the terminal determines whether one of the multicast packets received is a request packet requesting transmission of a feedback message indicating whether the multicast packets is received, for example, an ACK request packet.

When the method determines at operation 1120 that one of the multicast packets is not the ACK request packet, the method returns to operation 1110 and the terminal receives another coded packet based on the multicast packets.

When in the method determines at operation 1120 that one of the multicast packets is the ACK request packet, at operation 1130, the terminal generates the feedback message, for example, an ACK message. The terminal generates the ACK message based on a number of multicast packets or a set of multicast packets desired to be retransmitted.

At operation 1140, the terminal feeds back the ACK message to the AP.

Through feedback performed at operation 1140, the AP receives accumulated ACK messages from terminals and measures an accumulation level of the received packets and a length of the received packets to determine a scheme to retransmit the multicast packets.

In an embodiment, a length of a feedback message to be provided from the terminal is determined based on the number of the multicast packets or the set of the multicast packets desired by the terminal, to be retransmitted. The AP may determine the retransmission scheme based on the length of the feedback message.

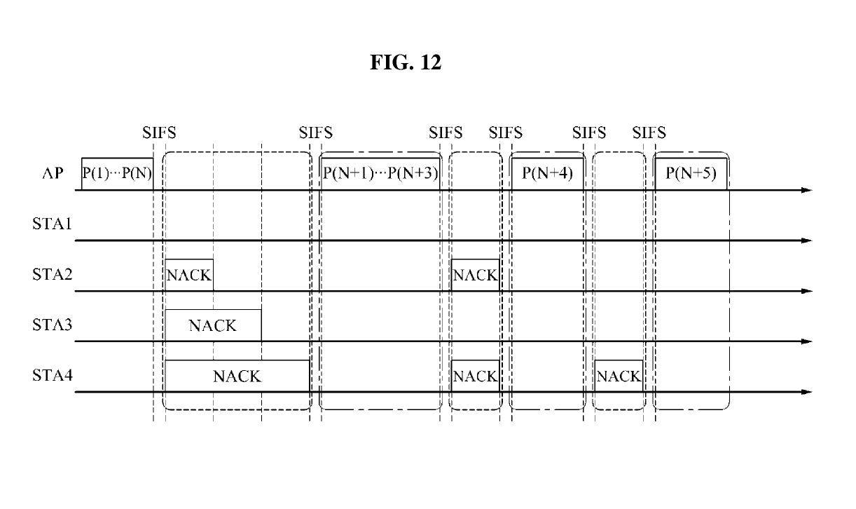

FIG. 12 illustrates an example of transferring a multicast packet via a WLAN using coded packet based multicast packets, in accord with an embodiment.

Referring to FIG. 12, an AP transfers packets via, for example, an Institute of Electrical and Electronics Engineers (IEEE) 802.11 WLAN standard using coded packet based multicast.

In a case in which the AP configures the multicast packets using, for example, linear network coding or rateless coding, each terminal may be provided with a multicast service when at least a predetermined number of packets are received, irrespective of types of the multicast packets.

Referring to FIG. 12, feeding method to feed back NACK messages from terminals to the AP using an unsolicited scheme is described, in accord with an embodiment.

The AP transmits coded packet based multicast packets P(1) through P(N) via wireless channels. Each of the terminals STA1, STA2, STA3, and STA4 may receive a different number of packets depending on a channel state. In one example, an i^{th} terminal STAi may generate a NACK message having a length corresponding to n_i*unit_time_of_NACK, using n_i denoting a number of packets desired to be retransmitted.

When an SIFS elapses after transmission of the multicast packets is terminated, terminals STA2, STA3, and STA4 failing to receive the multicast packets may feed back NACK messages to the AP simultaneously.

For example, when the AP multicasts N coded packets and after an SIFS elapses, each terminal receives the N multicast packets, and generates a NACK message based on a number of packets desired to be retransmitted. When NACK messages are fed back to the AP, the AP may retransmit three coded packets P(N+1) through P(N+3) based on a NACK message having the longest length, for example, the NACK message of the terminal STA4. The foregoing operation may be performed continuously by the AP and the terminals until the multicast packets are successfully received by all terminals. When a NACK message is not fed back by any terminal, the AP terminates the retransmission.

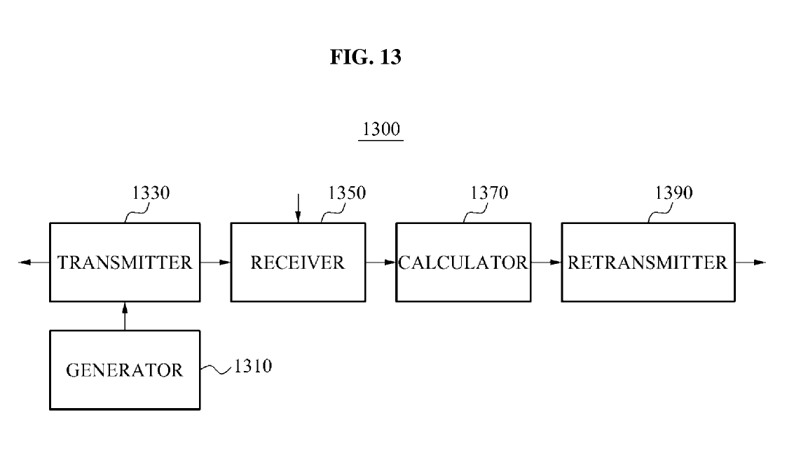

FIG. 13 illustrates an example of an AP 1300 to retransmit a multicast packet based on feedback, in accord with an embodiment.

Referring to FIG. 13, the AP 1300 includes a generator 1310, a transmitter 1130, a receiver 1350, a calculator 1370, and a retransmitter 1390.

The generator 1310 generates coded packet based multicast packets. The generator 1310 configures the multicast packets using, for example, linear network coding or rateless coding.

The transmitter 1330 transmits the multicast packets to a plurality of terminals.

In response to the transmission performed by the transmitter 1330, the receiver 1350 receives from at least one terminal, a feedback message indicating whether the multicast packets are received. The feedback message may include a NACK message indicating a failed reception of at least one of the multicast packets or an ACK message indicating a successful reception of at least one of the multicast packets.

The calculator 1370 calculates a number of multicast packets to be retransmitted based on a length of the feedback message.

The retransmitter 1390 retransmits at least one multicast packet to the at least one terminal based on a result of the calculating performed at the calculator 1370.

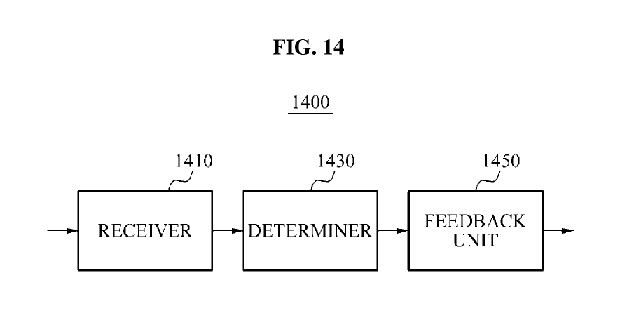

FIG. 14 illustrates an example of a terminal 1400 to retransmit a multicast packet based on feedback, in accord with an embodiment.

Referring to FIG. 14, the terminal 1400 providing feedback using an unsolicited scheme includes a receiver 1410, a determiner 1430, and a feedback unit 1450.

The receiver 1410 receives coded packet based multicast packets from an AP.

The determiner 1430 determines whether one of the received multicast packets is a last multicast packet by reading information in a header of the one multicast packet.

Based on a result of the determining performed by the determiner 1430, the feedback unit 1450 outputs to the AP a feedback message indicating whether the multicast packets is received.

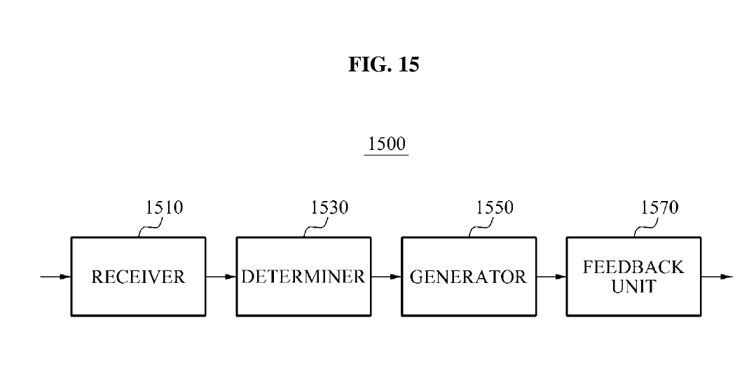

FIG. 15 illustrates another example of a terminal 1500 to retransmit a multicast packet based on feedback, in accord with an embodiment.

Referring to FIG. 15, the terminal 1500 providing feedback using a solicited scheme includes a receiver 1510, a determiner 1530, a generator 1550, and a feedback unit 1570.

The receiver 1510 receives coded packet based multicast packets from an AP.

The determiner 1530 determines whether one of the received multicast packets is a request packet requesting transmission of a feedback message, which indicates whether the multicast packets are received.

The generator 1550 generates the feedback message based on a result of the determining performed at the determiner 1530.

The feedback unit 1570 provides the feedback message to the AP.

According to embodiments, through use of coded packet based multicast, a message generated based on a number of multicast packets desired, from a terminal, to be retransmitted may be fed back, rather than individual packets requested for each terminal.

According to some embodiments, through use of coded packet based multicast, an AP may calculate a number of multicast packets to be retransmitted based on a length of a feedback message, which indicates whether multicast packets are received. The AP may also determine an error rate of a terminal based on an accumulation level of feedback, or perform an open-loop rate control using a result of feedback. In one illustrative configuration, the calculator 1370 in the AP 1300 may perform the determination of the error rate or open-loop rate control.

According to an embodiment, through use of a dummy packet for feedback, an anonymous operation may be performed without an association for multicast.

The units and apparatuses described herein may be implemented using hardware components. The hardware components may include, for example, controllers, sensors, processors, generators, drivers, and other equivalent electronic components. The hardware components may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The hardware components may run an operating system (OS) and one or more software applications that run on the OS. The hardware components also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a hardware component may include multiple processors or a processor and a controller. In addition, different processing configurations are possible, such a parallel processors.

The methods, according to the above-described embodiments, may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A communication method of an access point (AP), the communication method comprising:
transmitting a plurality of coded packet based multicast packets to terminals;
receiving, from a terminal, a feedback message indicating whether the multicast packets are received at the terminals; and
retransmitting a multicast packet to the terminal in response to the feedback message.

2. The communication method of claim 1, wherein the retransmitting comprises:
calculating a number of multicast packets to be retransmitted based on a length of the feedback message and outputting a result indicative thereof; and
retransmitting the multicast packet based on the result.

3. The communication method of claim 1, wherein the retransmitting comprises:
measuring an accumulation level of the feedback message and a length of the feedback message and outputting a result indicative thereof; and
determining a transmission scheme to retransmit the multicast packet based on the result.

4. The communication method of claim 1, wherein the transmitting comprises:
adding to a header of one of the multicast packets information indicating that the one multicast packet is a last multicast packet; and
transmitting to the terminals the multicast packet to which the information is added.

5. The communication method of claim 1, wherein the transmitting comprises:
transmitting a request message requesting the terminals to provide a feedback message when one of the multicast packets is a last multicast packet.

6. The communication method of claim 1, further comprising:
determining an error rate of a terminal based on an accumulation level of the feedback message.

7. The communication method of claim 1, further comprising:
terminating retransmission of the multicast packet in response to the feedback message being provided.

8. The communication method of claim 1, wherein the feedback message is provided using one of an unsolicited scheme from the terminal and a solicited scheme by the AP.

9. The communication method of claim 1, wherein the feedback message comprises one of a negative acknowledgement (NACK) message indicating a failed reception of one of the multicast packets and an acknowledgement (ACK) message indicating a successful reception of one of the multicast packets.

10. A non-transitory computer-readable medium configured to control a processor to perform the method of claim 1.

11. A communication method of a terminal, the communication method comprising:
receiving a plurality of coded packet based multicast packets from an access point (AP);
determining one of the multicast packets as a last multicast packet and outputting a result indicative thereof; and
providing, to the AP, a feedback message indicating whether the multicast packets are received based on the result.

12. The communication method of claim 11, wherein the determining of the last multicast packet is based on reading information from a header of the one multicast packet.

13. The communication method of claim 11, wherein the providing comprises generating the feedback message when one of the multicast packets is determined to be the last multicast packet.

14. The communication method of claim 13, wherein the generating comprises generating the feedback message to be retransmitted at the terminal based on a number of multicast packets or a set of multicast packets desired.

15. The communication method of claim 13, wherein a length of the feedback message to be retransmitted varies based on a number of multicast packets or a set of multicast packets desired, by the at least one terminal.

16. The communication method of claim 11, wherein the providing comprises providing the feedback message at a predetermined time to the AP.

17. A communication method of a terminal, the communication method comprising:
receiving a plurality of coded packet based multicast packets from an access point (AP);
determining whether one of the multicast packets is a request packet requesting transmission of a feedback message and outputting a result indicative thereof, wherein the feedback message indicates whether the multicast packets are received;
generating the feedback message based on the result; and
transmitting the feedback message to the AP.

18. The communication method of claim 17, wherein the generating comprises generating the feedback message to be retransmitted from a terminal based on a number of multicast packets or a set of multicast packets desired.

19. An access point (AP), comprising:
a transmitter configured to transmit a plurality of coded packet based multicast packets to terminals;
a receiver configured to receive, from one of the terminals, a feedback message indicating whether the multicast packets are received at the terminals;
a calculator configured to calculate a number of multicast packets to be retransmitted based on a length of the feedback message and to output a result indicative thereof; and
a retransmitter configured to retransmit a multicast packet to the terminal based on the result.

20. The AP of claim 19, wherein the calculator is further configured to determine an error rate of a terminal based on an accumulation level of the feedback message.

21. The AP of claim 19, wherein the calculator is further configured to perform an open-loop rate control using the result.

22. A terminal, comprising:
a receiver configured to receive a plurality of coded packet based multicast packets from an access point (AP);
a determiner configured to determine one of the multicast packets as a last multicast packet and to output a result indicative thereof; and
a feedback unit configured to provide, to the AP, a feedback message indicating whether the multicast packets are received based on the result.

23. The communication method of claim 22, wherein the determiner is configured to determine the last multicast packet by reading information in a header of the one multicast packet.

24. A terminal, comprising:
a receiver configured to receive a plurality of coded packet based multicast packets from an access point (AP);
a determiner configured to determine whether one of the multicast packets is a request packet requesting transmission of a feedback message and to output a result indicative thereof, wherein the feedback message indicates whether the multicast packets are received;
a generator configured to generate the feedback message based on the result; and
a feedback unit configured to transmit the feedback message to the AP.
